(19) United States
(12) Patent Application Publication
(10) Pub. No.: US 2026/0241580 A1
(43) Pub. Date: Aug. 20, 2026

(54) GRIPPER AND ROBOT INCLUDING THE SAME

(71) Applicants: HYUNDAI MOTOR COMPANY, Seoul (KR); Kia Corporation, Seoul (KR)

(72) Inventors: Beom Su KIM, Hwaseong-si (KR); Hyun Seop LIM, Hwaseong-si (KR); Duk Chan YOON, Hwaseong-si (KR); Dong Jin HYUN, Hwaseong-si (KR); Ju Young YOON, Hwaseong-si (KR)

(21) Appl. No.: 19/301,320

(22) Filed: Aug. 15, 2025

(30) Foreign Application Priority Data
Feb. 19, 2025 (KR) 10-2025-0021718

(51) Int. Cl. B25J 15/02

(52) U.S. Cl. CPC B25J 15/022

(57) ABSTRACT

A gripper includes a linkage rotatably coupled to a base body and a fingertip rotatably connected to the linkage. The linkage includes a first link part having one side configured to be rotatable relative to one side of the base body, and the other side rotatably coupled to the fingertip, and a second link part having one side rotatably coupled to the one side of the base body, and the other side configured to be rotatable relative to the fingertip.

### CROSS-REFERENCE TO RELATED APPLICATION

This application claims priority to and the benefit of Korean Patent Application No. 10-2025-0021718, filed in the Korean Intellectual Property Office on Feb. 19, 2025, the entire contents of which are incorporated herein by reference.

### TECHNICAL FIELD

The present disclosure relates to a gripper and a robot including the same, and more particularly, to a gripper, which is capable of mimicking human hand motions, and a robot including the same.

### BACKGROUND

An adaptive gripper refers to a gripper having a structure capable of being transformed into various shapes according to shapes of items to be gripped and situations in which the gripper grips items. The adaptive gripper may be advantageous in gripping various types of items. In some cases, a number of power sources may be consumed to change the shapes of the gripper, which may lead to increases in weight, volume, and manufacturing cost of the gripper.

In some cases, some components of the gripper may be substituted with flexible bands in order to reduce the number of power sources. In some cases, because of the nature of the material of the band, the performance of the gripper may vary depending on the temperature of the environment in which the gripper is used, and the durability of the band may be limited, which may result in instability in gripping an item.

### SUMMARY

The present disclosure describes an adaptive gripper with a structure capable of being transformed into various shapes and stably gripping an item while reducing the number of power sources.

According to one aspect of the subject matter described in this application, a gripper includes a base body, a linkage disposed at a side of the base body and rotatably coupled to the base body, and a fingertip disposed at a side of the linkage and rotatably connected to the linkage. The linkage includes a first link part and a second link part. The first link part has (i) a first side rotatably coupled to the side of the base body and (ii) a second side that is rotatable relative to the fingertip, the first link part including a first-first link that is disposed at the first side of the first link part and rotatably coupled to a first region at the side of the base body. The second link part has (i) a first side rotatably coupled to the side of the base body and (ii) a second side that is rotatable relative to the fingertip, the second link part including a second-first link that is disposed at the first side of the second link part and rotatably coupled to a second region at the side of the base body. The first-first link is configured to, based on an external force being removed from the gripper, define a first angle between a lower surface of the base body and a first extension direction of the first-first link from the first region of the base body. The second-first link is configured to, based on the external force being removed from the gripper, define a second angle between the lower surface of the base body and a second extension direction of the second-first link from the second region of the base body, where the second angle is different from the first angle.

Implementations according to this aspect can include one or more of the following features. For example, the first angle can be smaller than the second angle. In some implementations, the gripper can further include one or more springs that connect the base body to the linkage, where the one or more springs include a first spring having (i) a first side connected to the base body and (ii) a second side connected to the first-first link. In some examples, the one or more springs can further include a second spring having (i) a first side connected to the base body and (ii) a second side connected to the second-first link.

In some implementations, the first link part can further include a first-second link that has a first side rotatably coupled to the first-first link. The first-second link can have a second side rotatably coupled to the fingertip. In some examples, the second link part can further include a second-second link having a first side rotatably coupled to the second-first link. In some examples, the second link part can further include a second-third link having a first side rotatably coupled to the second-second link, and a common link having (i) a first side rotatably coupled to the second-third link and (ii) a second side rotatably coupled to the fingertip, where, in a state in which the base body is disposed parallel to a horizontal direction, a rotation center axis of the common link with respect to the second-third link intersects the horizontal direction.

In some examples, the base body can include a plate member having a plate shape, a first base link having (i) a first side rotatably coupled to the plate member and (ii) a second side rotatably coupled to the first-first link, and a second base link having (i) a first side rotatably coupled to the plate member and (ii) a second side rotatably coupled to the second-first link. In some examples, in a state in which the plate member is disposed parallel to a horizontal direction, a rotation center axis of the first base link with respect to the plate member can intersect the horizontal direction. In some examples, in a state in which the plate member is disposed parallel to a horizontal direction, a rotation center axis of the second base link with respect to the plate member can intersect the horizontal direction.

In some implementations, the second link part can be one of a second-first link part and a second-second link part, each of the second-first link part and the second-second link part including the second-first link, the second-second link, and the second-third link, where the second-third link of each of the second-first link part and the second-second link part is rotatably coupled to the common link. In some examples, the common link can have (i) a first side rotatably coupled to the second-third link of the second-first link part, (ii) a second side rotatably coupled to the second-third link of the second-second link part, and (iii) a third side rotatably coupled to the fingertip. In some examples, the first side of the common link and the second side of the common link can face each other, where the third side of the common link is interposed between the first side of the common link and the second side of the common link.

In some implementations, the fingertip can include a flat fingertip surface and a curved fingertip surface disposed at a side of the flat fingertip surface, the curved fingertip surface being convex in a direction away from the linkage. In some examples, in a state in which the external force is removed from the gripper, the first side of the first-second link coupled to the first-first link is horizontally spaced apart from (i) the second side of the first-second link coupled to the fingertip and (ii) the first region of the base body coupled to the first-first link in a first horizontal direction, where the flat fingertip surface is spaced apart from the second side of the first-second link in a second horizontal direction opposite to the first horizontal direction. In some implementations, the curved fingertip surface can extend upward and in the first horizontal direction from a lower end of the flat fingertip surface in the state in which the external force is removed from the gripper.

According to another aspect, a robot includes a plurality of grippers configured to move toward one another and move away from one another, each of the plurality of grippers including the gripper described above.

In some implementations, the adaptive gripper can have the structure capable of being transformed into various shapes and stably gripping an item while minimizing the number of power sources.

### BRIEF DESCRIPTION OF THE DRAWINGS

FIG. 1 is a perspective view illustrating an example of a gripper.

FIG. 2 is a side view illustrating the gripper in a state in which an external force is removed from the gripper in FIG. 1, other than gravity.

FIG. 3 is a side view illustrating an example of a base body, a fingertip, an a first link part of the gripper, in an example state in which the base body is moved downward in a state in which the fingertip of the gripper in FIG. 2 is in contact with a ground surface, such that a first link member of the first link part interferes with the base body.

FIG. 4 is a side view illustrating an example state in which the fingertip begins to rotate as the base body of the gripper is additionally moved downward in the state in FIG. 3.

FIG. 5 is a side view illustrating an example state in which the fingertip is additionally rotated as the base body of the gripper is additionally moved downward in the state in FIG. 4, such that a flat fingertip surface of the fingertip is directed upward.

FIG. 6 is a view illustrating an example of a robot including the grippers that grip an item by second link parts.

FIG. 7 is a view illustrating an example state in which the grippers of the robot grip an item by the fingertips.

### DETAILED DESCRIPTION

Hereinafter, a gripper and a robot will be described with reference to the drawings.

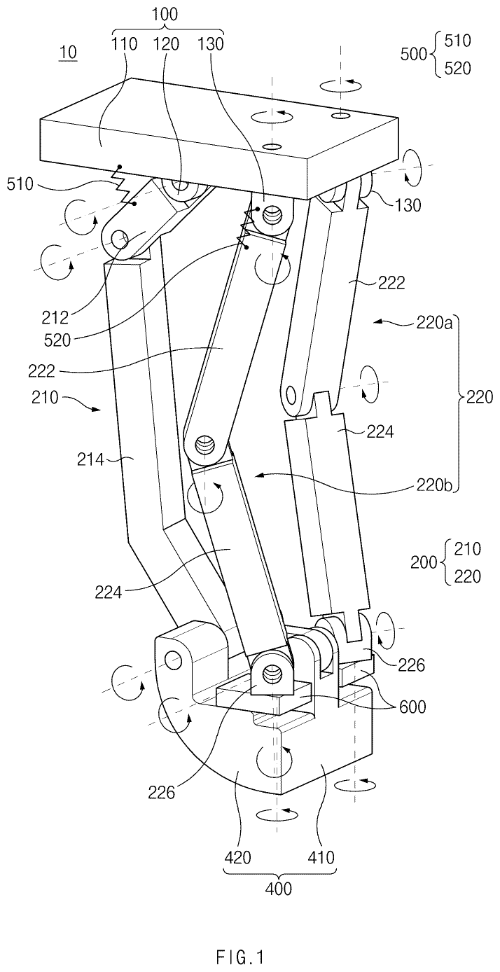

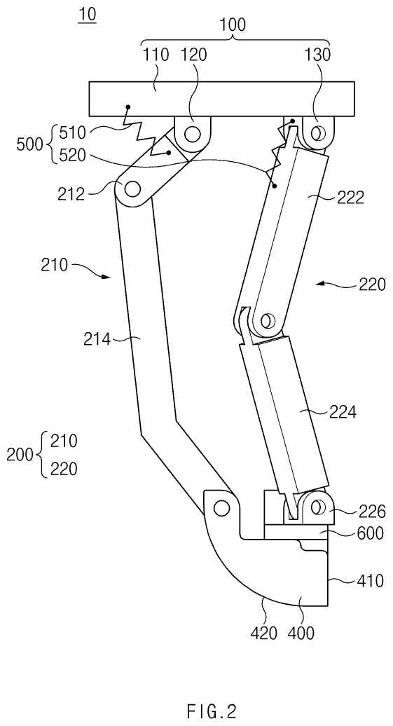

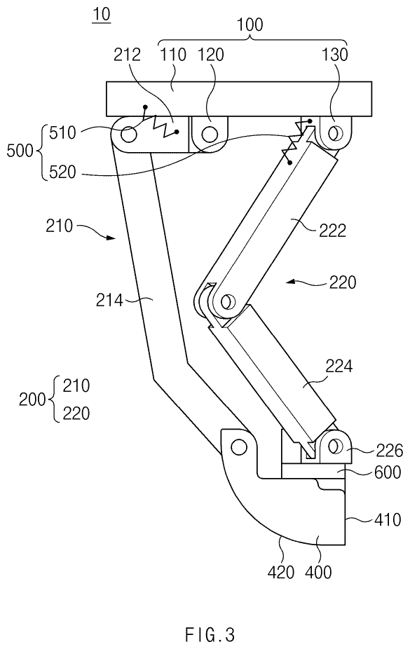

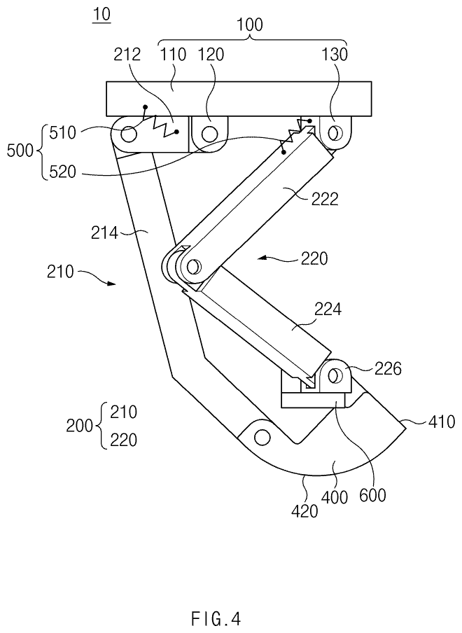

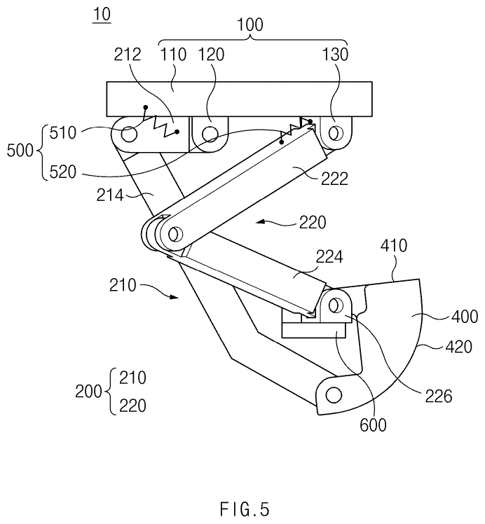

FIG. 1 is a perspective view illustrating an example of a gripper. FIG. 2 is a side view illustrating an example state in which an external force is removed from the gripper in FIG. 1, other than gravity, and FIG. 3 is a side view illustrating a state in which a base body of the gripper is moved downward in a state in which a fingertip of the gripper in FIG. 2 is in contact with a ground surface, such that a first link member of a first link part interferes with the base body. FIG. 4 is a side view illustrating a state in which the fingertip begins to rotate as the base body of the gripper is additionally moved downward in the state in FIG. 3, and FIG. 5 is a side view illustrating a state in which the fingertip is additionally rotated as the base body of the gripper is additionally moved downward in the state in FIG. 4, such that a flat fingertip surface of the fingertip is directed upward.

A gripper 10 can serve as an end effector of a robot to be described below. More specifically, the gripper can freely change in shape in various working environments, such that the gripper can effectively grip various types of items.

With reference to FIGS. 1 to 5, the gripper 10 can include a base body 100. The base body 100 can be a component coupled directly to another part of the robot, e.g., other than the gripper.

In addition, the gripper 10 can further include a linkage 200 provided at one side of the base body 100 and rotatably coupled to the base body 100. The drawings illustrate a state in which the linkage 200 is coupled to a lower portion of the base body 100., the linkage 200 of the gripper 10 can be configured to change in shape during a process in which the gripper grips an item. As described below, the linkage 200 can include a plurality of link members rotatably coupled to one another.

In addition, the gripper 10 can further include a fingertip 400 provided at one side of the linkage 200 and rotatably connected to the linkage 200. The fingertip 400 can be configured to come into direct contact with an item during the process in which the gripper 10 is used to grip the item. The drawings illustrate a state in which the fingertip 400 is coupled to a lower portion of the linkage 200. As described below, the fingertip 400 can directly grip the item or support a lower surface of the item during the process of gripping the item using the gripper.

In some examples, in the gripper 10, the linkage 200 can include a plurality of sub-link parts. More specifically, the linkage 200 can include a first link part 210 having one side rotatably coupled to one side of the base body 100, and the other side configured to be rotatable relative to the fingertip 400, and a second link part 220 having one side rotatably coupled to one side of the base body 100, and the other side configured to be rotatable relative to the fingertip 400. The first link part 210 and the second link part 220 can be physically spaced apart from each other. The portions of the first and second link parts 210 and 220, which are coupled to the base body 100, can also be physically spaced apart from each other.

In addition, the first link part 210 can include a first-first link 212 having one side rotatably coupled to one side of the base body 100. The second link parts 220 can include second-first links 222 each having one side rotatably coupled to one side of the base body 100.

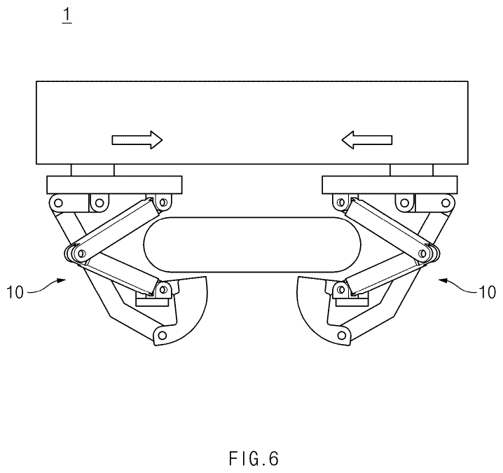

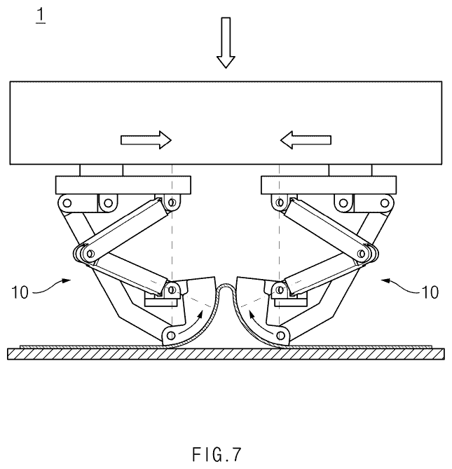

In some implementations, the item, which is gripped during the process of gripping the item by using the gripper 10, can be positioned to be closer to the second link part 220 than the first link part 210. For example, in case that the item is gripped in the state in which the fingertip 400 supports the item from below the item, the second link parts 220 can press the item in a leftward/rightward direction (see FIG. 6). More specifically, when the item is gripped by being pressed by the second link parts 220 in the leftward/rightward direction, the second link parts 220 can be entirely bent in a direction away from the gripped item, i.e., a direction toward the first link part 210. The process of bending the second link part 220 can be equally performed even in case that the item is gripped by pressing the fingertip 400 in the leftward/rightward direction (see FIG. 7).

In some examples, in case that the item is gripped by using the second link part 220 or the fingertip 400, the first link part 210 prevents the second link part 220 from being bent beyond a predetermined range, thereby generating a supporting force to grip the item. More specifically, in case that the first-first link 212 of the first link part 210 rotates by a predetermined rotation angle relative to the base body 100, the first-first link 212 can interfere with the base body 100, thereby generating the above-mentioned supporting force.

In some implementations, as illustrated in FIGS. 1 and 2, in a state in which an external force, other than gravity, applied to the gripper 10 is removed, i) an angle defined between a direction extending from a region in which the first-first link 212 is coupled to the base body 100 and the lower surface of the base body 100 and ii) an angle defined between a direction extending from a region in which the second-first link 222 is coupled to the base body 100 and the lower surface of the base body 100 can be different from each other. More specifically, in the state in which the external force applied to the gripper 10 is removed, i) the angle defined between the direction extending from the region in which the first-first link 212 is coupled to the base body 100 and the lower surface of the base body 100 can be smaller than ii) the angle defined between the direction extending from the region in which the second-first link 222 is coupled to the base body 100 and the lower surface of the base body 100. Therefore, the first-first link 212 can interfere with the base body 100 first before the second-first link 222 interferes with the base body 100 during a process in which the first-first link 212 and the second-first link 222 rotate relative to the base body 100 during the process of gripping the item (see FIG. 3).

In some examples, with reference back to FIG. 1 and the like, the gripper can further include one or more springs 500 each having one side connected to the base body 100, and the other side connected to the linkage 200. The one or more springs 500 can be configured to maintain a predetermined shape of the linkage 200 in the state in which the external force, other than gravity, is removed from the gripper 10.

More specifically, the one or more springs 500 can include a first spring 510 having one side connected to the base body 100, and the other side connected to the first-first link 212. Therefore, a relative position between the first-first link 212 and the base body 100 can be maintained by the first spring 510 even in the state in which the external force is removed.

In addition, the one or more springs 500 can further include a second spring 520 having one side connected to the base body 100, and the other side connected to the second-first link 222. Therefore, a relative position between the second-first link 222 and the base body 100 can be maintained by the second spring 520 even in the state in which the external force is removed.

With continued reference to FIGS. 1 to 5, the first link part 210 can further include a first-second link 214 having one side rotatably coupled to the first-first link 212. More specifically, the other side of the first-second link 214 can be rotatably coupled to the fingertip 400. More particularly, in the state in which the external force is removed, the first link part 210 including the first-first link 212 and the first-second link 214 can be in a state in which the first link part 210 is entirely bent in the direction away from the item gripped by the gripper.

In some examples, the second link part 220 can further include a second-second link 224 having one side rotatably coupled to the second-first link 222, and a second-third link 226 having one side rotatably coupled to the second-second link 224. More particularly, in the state in which the external force is removed, the second link part 220 including the second-first link 222, the second-second link 224, and the second-third link 226 can be in a state in which the second link part 220 is entirely bent in the direction away from the item gripped by the gripper.

In addition, the gripper 10 can further include a common link 600 having one side rotatably coupled to the second-third link 226, and the other side rotatably coupled to the fingertip 400. Therefore, the second link parts 220 can be connected indirectly to the fingertip 400 by the common link 600.

In this case, in a state in which the base body 100 is disposed in parallel with a horizontal direction, a rotation center axis of the common link 600 with respect to the second-third link 226 can extend in a direction intersecting the horizontal direction. For example, the rotation center axis of the common link 600 with respect to the second-third link 226 can extend in an upward/downward direction.

In some examples, the base body 100 can include a plurality of components. More specifically, the base body 100 can include a plate member 110 having a plate shape, a first base link 120 having one side rotatably coupled to the plate member 110, and the other side rotatably coupled to the first-first link 212, and second base links 130 each having one side rotatably coupled to the plate member 110, and the other side rotatably coupled to the second-first link 222.

In this case, as illustrated in FIGS. 1 to 5, in the state in which the plate member 110 is disposed in parallel with the horizontal direction, a rotation center axis of the first base link 120 with respect to the plate member 110 can extend in the direction intersecting the horizontal direction. For example, a rotation center axis of the first-first link 212 with respect to the first base link 120 can extend in the upward/downward direction.

In addition, in the state in which the plate member 110 is disposed in parallel with the horizontal direction, a rotation center axis of the second base link 130 with respect to the plate member 110 can extend in the direction intersecting the horizontal direction. For example, a rotation center axis of the second-first link 222 with respect to the second base link 130 can extend in the upward/downward direction.

In some examples, one side of the first spring 510 can be connected to the plate member 110, and the other side of the first spring 510 can be connected to the first-first link 212. In addition, one side of the second spring 520 can be connected to the second base link 130, and the other side of the second spring 520 can be connected to the second-first link 222.

In some implementations, in the gripper 10, one first link part 210 can be provided, and two second link parts 220 can be provided.

More specifically, the second link parts 220 can include a second-first link part 220a and a second-second link part 220b each including the second-first link 222, the second-second link, and the second-third link 226. That is, the second-first link part 220a and the second-second link part 220b provided in the gripper 10 can be identical to each other to the extent that the second-first link part 220a and the second-second link part 220b are interchangeable with each other.

In this case, as illustrated in FIG. 1 and the like, the second-third link 226, which is provided in the second-first link part 220a, and the second-third link 226, which is provided in the second-second link part 220b, can be rotatably coupled to the common link 600.

In some examples, from the point of view of the common link 600, the common link 600 can be rotatably coupled to the first link part 210, the second-first link part 220a, and the second-second link part 220b in the gripper 10. More specifically, i) a first side of the common link 600 can be rotatably coupled to the second-third link 226 provided in the second-first link part 220a, ii) a second side of the common link 600 can be rotatably coupled to the second-third link 226 provided in the second-second link part 220b, and iii) a third side of the common link 600 can be rotatably coupled to the fingertip 400. More particularly, the first side of the common link 600 and the second side of the common link 600 can be provided to face each other in the horizontal direction with the third side of the common link 600 interposed therebetween.

FIG. 6 is a view illustrating a state in which a robot including the grippers grips an item by the second link parts, and FIG. 7 is a view illustrating a state in which the robot including the grippers grips an item by the fingertips.

In some implementations, an outer surface of the fingertip 400 can include a plurality of regions having different shapes. For example, the fingertip 400 can include a flat fingertip surface 410 having a flat shape, and a curved fingertip surface 420 provided at one side of the flat fingertip surface 410 and having a convex curved shape.

The case in which the gripper 10 is used to grip an item can be classified into two cases. As illustrated in FIG. 6, the first case is a case in which the second link parts 220 press the item in the horizontal direction to grip the item in the state in which the fingertips 400 support the item upward. As illustrated in FIG. 7, the second case is a case in which the fingertips 400 press the item in the horizontal direction to grip the item.

In this case, in the above-mentioned first case, the component, which supports the item upward, can be the flat fingertip surface 410 of the fingertip 400. In the above-mentioned second case, the component, which presses the item in the horizontal direction, can be the curved fingertip surface 420 of the fingertip 400.

In order for the fingertip 400 to exhibit the above-mentioned function, in the state in which the external force applied to the gripper 10 is removed, a region in which the first-second link 214 is coupled to the first-first link 212 can be spaced apart, in a first horizontal direction W1, from a region in which the first-first link 212 is coupled to the base body and a region in which the first-second link 214 is coupled to the fingertip 400, and the flat fingertip surface 410 can be spaced apart from the region, in which the first-second link 214 is coupled to the fingertip 400, in a second horizontal direction W2 opposite to the first horizontal direction W1. That is, the second horizontal direction W2 can be a direction in which the first link part 210 faces the gripped item. More specifically, in the state in which the external force applied to the gripper is removed, the flat fingertip surface 410 can be disposed to extend in a direction perpendicularly intersecting the horizontal direction. In this case, in the above-mentioned first case, i.e., during the process in which the second link part 220 grips the item, the fingertip 400 rotates relative to the first-second link 214, such that the flat fingertip surface 410 can be directed upward.

In some examples, in the state in which the external force applied to the gripper 10 is removed, the curved fingertip surface 420 can extend upward in the first horizontal direction W1 from a lower end of the flat fingertip surface 410. In this case, in the above-mentioned second case, i.e., during the process in which the fingertip 400 grips the item, the fingertip 400 rotates relative to the first-second link 214, such that the item pressed by the curved fingertip surface 420 can be moved upward. In particular, in the above-mentioned second case, it is possible to effectively grip the item in case that the item intended to be gripped has a sheet shape having a small thickness.

Hereinafter, a method of operating the gripper will be described with reference to FIGS. 1 to 5.

As illustrated in FIG. 2, in the state in which no external force is applied to the gripper other than gravity, the first link part 210 and the second link part 220 of the gripper 10 are kept slightly bent toward one side based on the horizontal direction.

Thereafter, when the gripper 10 is lowered and the fingertip 400 reaches the ground surface, the fingertip 400 is supported upward by the ground surface. Therefore, the base body 100 is lowered by a predetermined distance in the state in which the fingertip 400 is supported by the ground surface. Therefore, the first link part 210 and the second link part 220 are kept further bent in comparison with the state illustrated in FIG. 2. In particular, as illustrated in FIG. 3, when the gripper 10 is lowered by a predetermined distance, the first-first link 212 of the first link part 210 interferes with the lower surface of the plate member 110 of the base body 100, such that the rotational motion of the first-first link 212 relative to the first base link 120 is stopped.

In case that the base body 100 is further lowered even after the gripper 10 reaches the state illustrated in FIG. 3, the fingertip 400 rotates, as illustrated in FIG. 4. In particular, the fingertip 400 rotates relative to the first-second link 214 and the common link 600.

When the base body 100 is further lowered additionally even after the gripper 10 reaches the state illustrated in FIG. 4, the flat fingertip surface 410 of the fingertip 400 is directed upward, and the curved fingertip surface 420 of the fingertip 400 is directed laterally, as illustrated in FIG. 5.

In some implementations, in the state in which the plate member 110 is disposed in parallel with the horizontal direction, the rotation center axis of the first-first link 212 with respect to the first base link 120, the rotation center axis of the first-second link 214 with respect to the first-first link 212, the rotation center axis of the fingertip 400 with respect to the first-second link 214, the rotation center axis of the second-first link 222 with respect to the second base link 130, the rotation center axis of the second-second link 224 with respect to the second-first link 222, the rotation center axis of the second-third link 226 with respect to the second-second link 224, and the rotation center axis of the fingertip 400 with respect to the common link 600 can each be formed in parallel with the horizontal direction.

With reference to FIGS. 1 to 7, a robot 1 can have a plurality of grippers 10. For example, the robot 1 can include two grippers 10 that face each other in the horizontal direction based on the state in which the base body 100 is disposed in parallel with the horizontal direction. In this case, the plurality of grippers 10 can be configured to be movable in a direction in which the plurality of grippers 10 move toward one another or a direction in which the plurality of grippers 10 move away from one another. For example, the robot 1 can further include a power unit configured to provide power to move two grippers 10 in a direction in which the two grippers 10 move toward each other or a direction in which the two grippers 10 move away from each other. For example, the robot 1 can be a machine programmed to carry out one or more actions automatically.

The present disclosure has been described with reference to the limited embodiments and the drawings, but the present disclosure is not limited thereby. The present disclosure can be carried out in various forms by those skilled in the art, to which the present disclosure pertains, within the technical spirit of the present disclosure and the scope equivalent to the appended claims.

What is claimed is:

1. A gripper comprising:
a base body;
a linkage disposed at a side of the base body and rotatably coupled to the base body; and
a fingertip disposed at a side of the linkage and rotatably connected to the linkage,
wherein the linkage comprises:
a first link part having (i) a first side rotatably coupled to the side of the base body and (ii) a second side that is rotatable relative to the fingertip, the first link part comprising a first-first link that is disposed at the first side of the first link part and rotatably coupled to a first region at the side of the base body, and
a second link part having (i) a first side rotatably coupled to the side of the base body and (ii) a second side that is rotatable relative to the fingertip, the second link part comprising a second-first link that is disposed at the first side of the second link part and rotatably coupled to a second region at the side of the base body,
wherein the first-first link is configured to, based on an external force being removed from the gripper, define a first angle between a lower surface of the base body and a first extension direction of the first-first link from the first region of the base body, and
wherein the second-first link is configured to, based on the external force being removed from the gripper, define a second angle between the lower surface of the base body and a second extension direction of the second-first link from the second region of the base body, the second angle being different from the first angle.

2. The gripper of claim 1, wherein the first angle is smaller than the second angle.

3. The gripper of claim 1, further comprising:
one or more springs that connect the base body to the linkage,
wherein the one or more springs comprise a first spring having (i) a first side connected to the base body and (ii) a second side connected to the first-first link.

4. The gripper of claim 3, wherein the one or more springs further comprise a second spring having (i) a first side connected to the base body and (ii) a second side connected to the second-first link.

5. The gripper of claim 1, wherein the first link part further comprises a first-second link that has a first side rotatably coupled to the first-first link.

6. The gripper of claim 5, wherein the first-second link has a second side rotatably coupled to the fingertip.

7. The gripper of claim 1, wherein the second link part further comprises a second-second link having a first side rotatably coupled to the second-first link.

8. The gripper of claim 7, wherein the second link part further comprises:
a second-third link having a first side rotatably coupled to the second-second link; and
a common link having (i) a first side rotatably coupled to the second-third link and (ii) a second side rotatably coupled to the fingertip, and
wherein, in a state in which the base body is disposed parallel to a horizontal direction, a rotation center axis of the common link with respect to the second-third link intersects the horizontal direction.

9. The gripper of claim 1, wherein the base body comprises:
a plate member having a plate shape;
a first base link having (i) a first side rotatably coupled to the plate member and (ii) a second side rotatably coupled to the first-first link; and
a second base link having (i) a first side rotatably coupled to the plate member and (ii) a second side rotatably coupled to the second-first link.

10. The gripper of claim 9, wherein, in a state in which the plate member is disposed parallel to a horizontal direction, a rotation center axis of the first base link with respect to the plate member intersects the horizontal direction.

11. The gripper of claim 9, wherein, in a state in which the plate member is disposed parallel to a horizontal direction, a rotation center axis of the second base link with respect to the plate member intersects the horizontal direction.

12. The gripper of claim 8, wherein the second link part is one of a second-first link part and a second-second link part, each of the second-first link part and the second-second link part comprising the second-first link, the second-second link, and the second-third link, and
wherein the second-third link of each of the second-first link part and the second-second link part is rotatably coupled to the common link.

13. The gripper of claim 12, wherein the common link has (i) a first side rotatably coupled to the second-third link of the second-first link part, (ii) a second side rotatably coupled to the second-third link of the second-second link part, and (iii) a third side rotatably coupled to the fingertip.

14. The gripper of claim 13, wherein the first side of the common link and the second side of the common link face each other, the third side of the common link being interposed between the first side of the common link and the second side of the common link.

15. The gripper of claim 6, wherein the fingertip comprises:
a flat fingertip surface; and
a curved fingertip surface disposed at a side of the flat fingertip surface, the curved fingertip surface being convex in a direction away from the linkage.

16. The gripper of claim 15, wherein, in a state in which the external force is removed from the gripper, the first side of the first-second link coupled to the first-first link is horizontally spaced apart from (i) the second side of the first-second link coupled to the fingertip and (ii) the first region of the base body coupled to the first-first link in a first horizontal direction, and
wherein the flat fingertip surface is spaced apart from the second side of the first-second link in a second horizontal direction opposite to the first horizontal direction.

17. The gripper of claim 16, wherein the curved fingertip surface extends upward and in the first horizontal direction from a lower end of the flat fingertip surface in the state in which the external force is removed from the gripper.

18. The gripper of claim 1, wherein the first link part further comprises a first-second link that has (i) a first side rotatably coupled to the first-first link, (ii) a second side rotatably coupled to the fingertip, and (iii) a bent portion disposed between the first side and the second side of the first-second link.

19. The gripper of claim 18, wherein the second link part further comprises a second-second link having a first side that is rotatably coupled to the second-first link, the first side of the second-second link being disposed above the bent portion between the first side and the second side of the first-second link.

20. A robot comprising:
a plurality of grippers configured to move toward one another or move away from one another, each of the plurality of grippers comprising the gripper of claim 1.
